(19) United States
(12) Patent Application Publication
(10) Pub. No.: US 2010/0213211 A1
(43) Pub. Date: Aug. 26, 2010

(54) Bottle Cap With Dosing and Pretreatment

(76) Inventors: Audrey M. Whaling, Pleasanton, CA (US); John E. Jamieson, Pleasanton, CA (US); Shannon Fong, San Francisco, CA (US); Ramesh Annapindi, San Francisco, CA (US); Maarten Dinger, San Francisco, CA (US)

Correspondence Address: THE CLOROX COMPANY, P.O. BOX 24305, OAKLAND, CA, 94623-1305, US

(21) Appl. No.: 12/714,176

(22) Filed: Feb. 26, 2010

Related U.S. Application Data
(60) Provisional application No. 61/155,776, filed on Feb. 26, 2009.

(51) Int. Cl. B65D 47/12; B67D 1/16; B67D 7/06

(52) U.S. Cl. 222/111; 222/566; 222/109; 222/532; 222/536

(57) ABSTRACT

Described is a bottle having a bottle base, a transition fitment with a pouring spout and a measuring cup closure, where the measuring cup in multifunctional, for example, serving as a measuring cup, a bottle closure, and a pretreatment applicator.

### CROSS REFERENCE TO RELATED APPLICATIONS

This application claims the benefit of U.S. Provisional Application No. 61/155,776, filed Feb. 26, 2009, which is hereby incorporated by reference in its entirety.

### BACKGROUND OF THE INVENTION

1. Field of the Invention

This invention relates generally to bottles for dispensing liquids, such as liquid cleaners and the like. More particularly, the present invention relates generally to bottles with integral measuring caps with both pretreatment and pouring options.

2. Description of the Related Art

Considerable effort has been directed to packages for liquids including a container housing the liquid, a transition collar having a pouring spot mounted on the container outlet, and a measuring cup which serves as a closure for the container. For example, U.S. Pat. No. 4,550,862 shows a liquid product pouring and measuring package having a measuring cup which also serves as the closure for the package. The package includes a container including a container body with an upwardly extending finish and a dispensing orifice. A transition collar is mounted on the container finish and has a pouring spout and a circumscribing wall with fastening means on its interior surface. A measuring cup serves as a closure for the package and includes outwardly disposed fastening means adapted to mate with the inwardly facing fastening means on the transition collar to attach the measuring cup in the inverted position to the transition collar and thereby provide a closure for the package. U.S. Pat. No. 5,865,331 to Jacobs discloses a measuring cap having a thinner wall part inserted into the neck of a container.

These measuring cups serve as closures for the containers and to appropriately measure out liquid amounts from the container. However, what is needed is a multi-functional measuring cup that fits on an ergonomically bottle.

### SUMMARY OF THE INVENTION

In accordance with the principles of the present invention, in one embodiment, a bottle comprises a plastic container which comprises a plastic container body for housing a liquid having an upwardly extending finish provided with a dispensing opening; a transition collar mounted on the finish, the collar having an forwardly projecting pouring spout and a circumscribing wall spaced from the pouring spout, the circumscribing wall including a fastening means on the internal surface; a measuring cup adapted to serve as a closure for the container, the measuring cup having an open mouth, a top surface, a depending skirt-like sidewall and fastening means on the external surface of the sidewall adapted to cooperate with the transition collar fastening means; the measuring cup having a pretreatment closure that allows application of the liquid when the measuring cup is attached to the container.

According to another embodiment of the present invention, a bottle comprises a plastic container which comprises a plastic container body for housing a liquid having an upwardly extending finish provided with a dispensing opening; a transition collar mounted on the finish, the collar having a pouring spout and a circumscribing wall spaced from the pouring spout, the circumscribing wall including a fastening means on the internal surface; a measuring cup adapted to serve as a closure for the container, the measuring cup having an open mouth, a top surface, a depending skirt-like sidewall and fastening means on the external surface of the sidewall adapted to cooperate with the transition collar fastening means; wherein a portion of the sidewall is at an angle of greater than 90 degrees to the top surface.

According to a further embodiment of the present invention, a bottle comprises a plastic container which comprises a plastic container body for housing a liquid having an upwardly extending finish provided with a dispensing opening; a transition collar mounted on the finish, the collar having a pouring spout and a circumscribing wall spaced from the pouring spout, the circumscribing wall including a fastening means on the internal surface; a measuring cup adapted to serve as a closure for the container, the measuring cup having an open mouth, a top surface, a depending skirt-like sidewall and fastening means on the external surface of the sidewall adapted to cooperate with the transition collar fastening means; wherein the pouring spout has an adjustment mechanism to control the flow rate of liquid from the pouring spout.

The use of the bottle of the present invention, from a consumer perspective, would not differ from the use of any conventional dispensing bottle known in the art. The user would simply open the closure mechanism to dispense fluid from the bottle.

Further features and advantages of the present invention will become apparent to those of ordinary skill in the art in view of the detailed description of embodiments below, when considered together with the attached drawings and claims.

### BRIEF DESCRIPTION OF THE DRAWINGS

The foregoing aspects and others will be readily appreciated by the skilled artisan from the following description of illustrative embodiments when read in conjunction with the accompanying drawings, in which:

FIG. 1 shows a perspective view of a bottle in accordance with an embodiment of the present invention;

FIG. 2 shows an exploded perspective view of a bottle in accordance with an embodiment of the present invention;

FIG. 3 shows an exploded cross-sectional view of a measuring cup according to the present invention;

FIG. 4 shows an exploded perspective view of a bottle in accordance with an embodiment of the present invention;

FIG. 5 shows a perspective view of a bottle according to the present invention;

FIG. 6a shows a perspective view of a bottle according to the present invention;

FIG. 6b shows a plan view of a measuring cup according to the present invention;

FIG. 7 a perspective view of a bottle and measuring cup according to the present invention;

FIG. 8 shows a perspective view of a bottle in accordance with an embodiment of the present invention;

FIG. 9 shows a perspective view of a bottle and measuring cup in accordance with an embodiment of the present invention;

FIG. 10 shows an exploded plan view of a bottle in accordance with an embodiment of the present invention;

FIG. 11a shows a perspective view of a bottle and measuring cup in accordance with an embodiment of the present invention;

FIG. 11b shows a perspective view of a bottle and measuring cup in accordance with an embodiment of the present invention;

FIG. 12 shows a perspective view of a bottle in accordance with an embodiment of the present invention; and

FIG. 13 shows a perspective view of a bottle and measuring cup in accordance with an embodiment of the present invention.

### DETAILED DESCRIPTION

Reference will now be made to the drawings wherein like numerals refer to like parts throughout. For ease of description, the components of this invention are described in the normal (upright) operating position, and terms such as upper, lower, horizontal, top, bottom, etc., are used with reference to this position. It will be understood, however, that the components embodying this invention may be manufactured, stored, transported, used, and sold in an orientation other than the position described.

Figures illustrating the components of this invention show some conventional mechanical elements that are known and that will be recognized by one skilled in the art. The detailed descriptions of such elements are not necessary to an understanding of the invention, and accordingly, are herein presented only to the degree necessary to facilitate an understanding of the novel features of the present invention.

All publications, patents and patent applications cited herein, whether supra or infra, are hereby incorporated by reference in their entirety to the same extent as if each individual publication, patent or patent application was specifically and individually indicated to be incorporated by reference.

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

The term “bottle”, as used herein, is meant to mean and include any plastic container for holding a fluid. The term “acute”, as used herein, is meant to mean an angle whose measure is greater than 0 degrees but less than 90 degrees. The term “obtuse”, as used herein, is meant to mean an angle whose measure is greater than 90 degrees but less than 180 degrees. The term “oblique”, as used herein, is meant to mean an angle whose measure is not a multiple of 90 degrees. The term “forward directed spout”, as used herein, is meant to mean a pouring spout whose pouring direction is on the opposite side from the handle and the spout is directed at less than 45 degrees from the horizontal when the bottle is placed in its normal storage position on a flat surface. The term “inward curve”, as used herein, is meant to mean an arc whose radius passes into the container. The term “outward curve”, as used herein, is meant to mean an arc whose radius passes away from the container.

Measuring Cup with Push Tilt-Top Pretreatment Closure

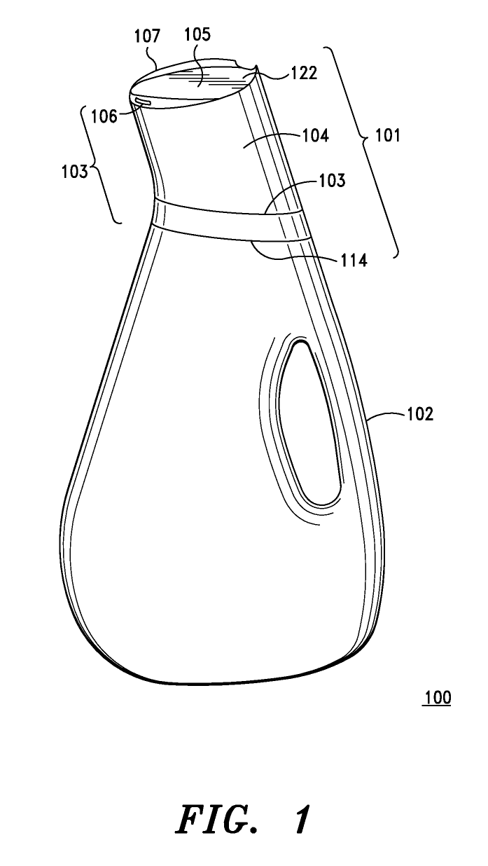

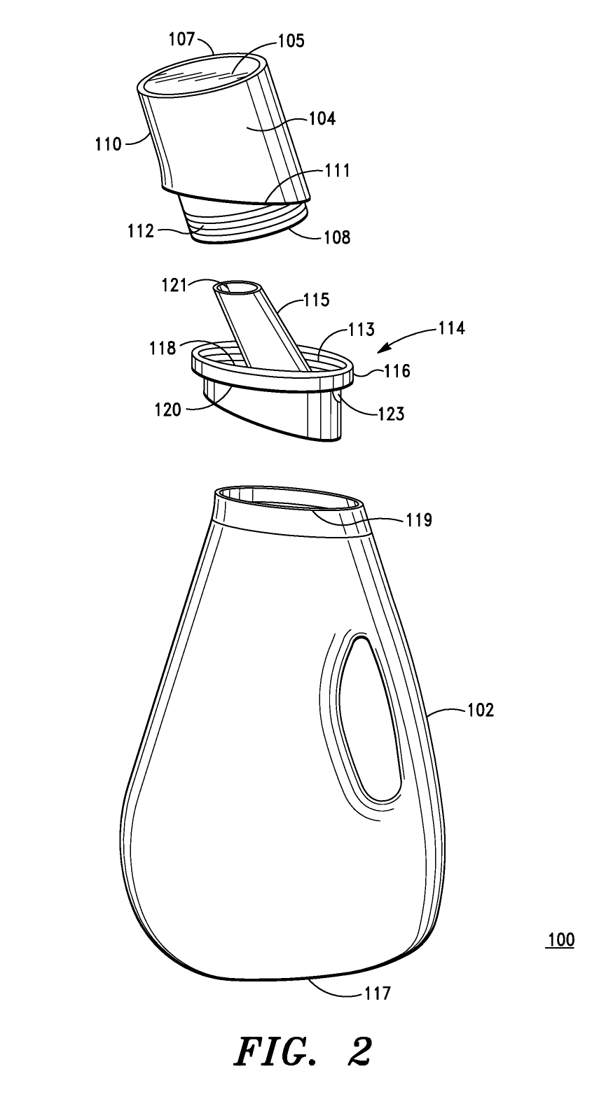

As shown in FIGS. 1 and 2, the bottle 100 is slanted having an inward curve 101 at the top of the measuring cup 104 slanted into the bottle 100 on the side with an integral handle 102 and an outward curve 103 at the top of the measuring cup 104 slanted away from the bottle 100 on the side opposite the handle 102. The bottle 100 has a measuring cup 104 with tilt-top closure 105 having a closure opening 106 on the top surface 107 of the measuring cup 104. The measuring cup 104 serves as a closure for the bottle 100. The measuring cup 104 has an open mouth 108, a top surface 107, a depending skirt-like sidewall 110, a bottle attachment base 111, and a fastening means 112, such as threads, on the external surface of the sidewall 110 below the attachment base 111. The measuring cup fastening means 112 cooperates with the fastening means 113 of transition collar 114. The transition collar 114 has a forward projecting pouring spout 115 angled with respect to the circumscribing wall 116 and the circumscribing wall 116 spaced from the pouring spout 115, where the circumscribing wall 116 includes a fastening means 113 on the internal surface of the circumscribing wall 116. The transition collar 114 is attached to the bottle 100 in such a fashion to allow a drain back channel 123. The attachment base 111 is slanted such that it is not parallel to the bottom portion 117 of the bottle 100 in the assembled state. The slanted attachment base 111 allows the measuring cup 104 to be attached in a forward-directed fashion pointed away from the side of the bottle 100 with the handle 102 so that the tilt-top closure opening 106 is directed forward of the top surface 118 of the transition collar 114. The top surface 118 of the transition collar 114 may be slanted such that it is not parallel to the bottom portion 117 of the bottle 100 when the transition collar 114 is attached to the bottle finish 119. The bottom surface 120 of the transition collar 114 may be slanted such that it is not parallel to the bottom portion 117 of the bottle 100 when the transition collar 114 is attached to the bottle finish 119. The upwardly extending pouring spout 115 is not coaxial with the transition collar 114, but is forward-directed away from the handle side 105 of the bottle 100 so that the pour spout opening 121 is directed to the front of the bottle 100 away from the handle 102, when the transition collar 114 is attached to the bottle finish 119. The spout opening 121 is suitably a beveled spout opening. The beveled spout opening 121 allows for easier pouring control from a forward-directed pour spout 115. The transition collar 114 is fixedly mounted on the upwardly extending circumferential bottle finish 119.

The forward directed tilt-top closure 105 allows the measuring cup 104 to serve two functions. One function is performed by opening the tilt-top closure 105 by pushing down on the side 122 opposite the tilt-top closure opening 106 to apply a small amount of liquid, such as for laundry pretreatment. Another function is performed by removing the measuring cup 104 with the tilt-top closure 105 in the closed position and filling the measuring cup 104 with a measured amount of liquid, such as laundry product for the wash. Example of a tilt-top closures are disclosed in U.S. Pat. No. 5,931,357 to Wass and U.S. Pat. No. 5,341,960 to Lay, which are incorporated by reference in their entirety herein.

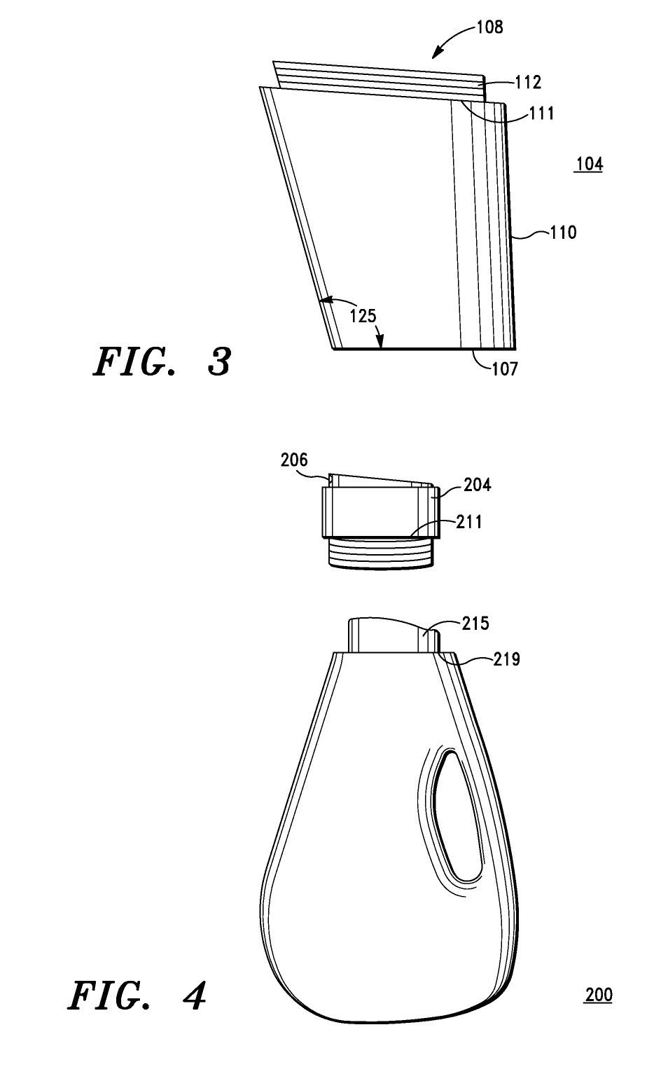

In a suitable embodiment, as shown in FIG. 3, the measuring cup 104 has an open mouth 108, a top surface 107, a depending skirt-like sidewall 110, and a fastening means 112, such as threads. In a suitable embodiment, the bottle attachment base 111 is oblique relative to the top surface 107, such that the attachment base 111 is not parallel to the measuring cup top surface 107. The measuring cup is forward leaning and has an obtuse angle, such that an angle 125 between a portion of the sidewall 110 and the top surface 107 is greater than 90 degrees. The forward leaning and oblique shape of the measuring cup 104 may indicate to the consumer whether the measuring cup 104 is completely attached to the transition collar 114 as it is threaded in the aligned forward-directed position so as to prevent leaking.

FIG. 4 shows a traditional horizontal bottle 200 with a horizontal measuring cap 204 having a horizontal attachment base 211 attached to a horizontal bottle finish 219 over a vertical directed pour spout 215. The horizontal measuring cap 204 has a tilt-top opening 206 directly above the horizontal bottle finish 219.

Measuring Cup with Flip Pretreatment Closure

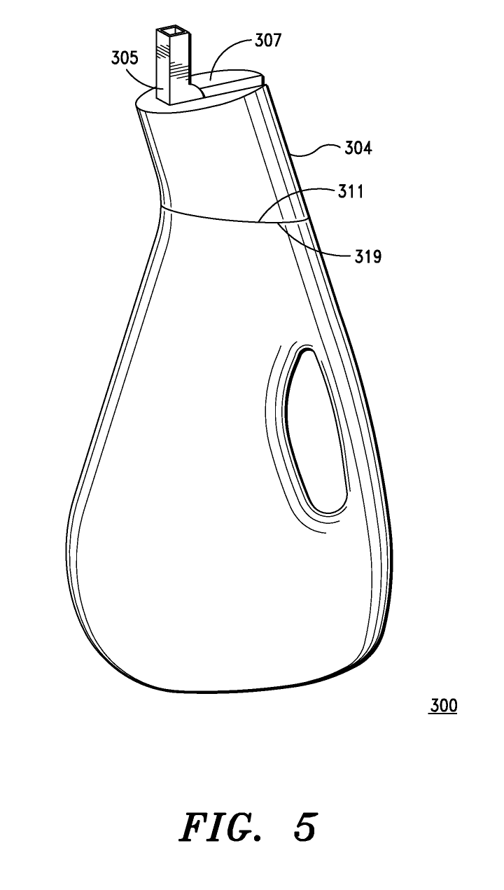

As shown in FIG. 5, the bottle 300 suitably has an obtuse measuring cup 304. The bottle attachment base 311 is oblique, such that the attachment base 311 is not parallel to the measuring cup top surface 307. The measuring cup top surface 307 has a turret closure 305 that can be opened to apply a small amount of product. In order to dose a larger amount of product, the turret closure 305 is closed and the measuring cup 304 removed and product is poured into the measuring cup 304 to dose the product appropriately. The measuring cup 304 may be directly attached to the bottle finish 319 or the measuring cup 304 may be attached to an intermediary transition collar (not shown). Examples of a pouring closure are disclosed in U.S. Pat. App. 20060102651 to Archeny, which is incorporated by reference in their entirety herein.

Measuring Cup with Scrubber

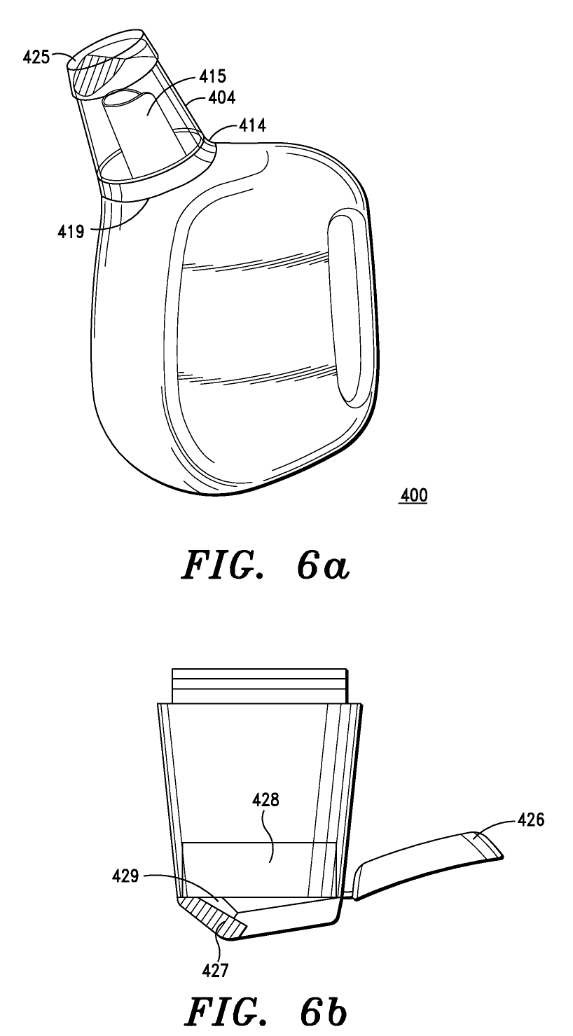

In a suitable embodiment in FIGS. 6a and 6b, the bottle 400 suitably has a measuring cup 404 with a top compartment 425 accessed by opening a flip cap 426 to provide a functional scrubber 427, such as plastic bristles or a sponge, for use in pretreating a substrate, such as laundry items. The functional scrubber 427 can be used to scrub in already applied product or liquid product 428 in the measuring cup 404 can be released to the scrubber 427 by pressing down to open a reversible seal 429. When the flip cap 426 is closed, the measuring cup can be used in a conventional manner to dose the product, such as laundry additive or laundry detergent. The measuring cup 404 is threadedly attached to a transition collar 414 having a forward-directed pouring spout 415. The transition collar 414 is fixedly attached to the slanted bottle finish 419. Example of a scrubber are disclosed in U.S. Pat. No. 6,353,954 to Dunsbergen and U.S. Pat. App. 20040159579 to Wenckels et al., which are incorporated by reference in their entirety herein.

### Rotating Dual Spout

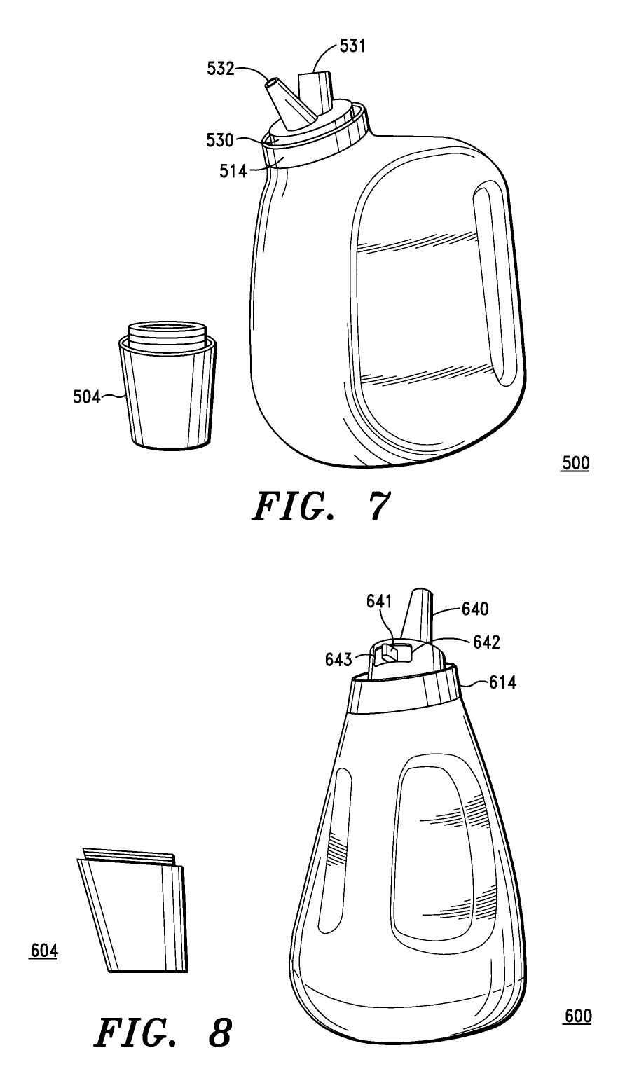

In a suitable embodiment in FIG. 7, the bottle 500 suitably has a dial turret 530 that can be rotated to fluidly align either the pouring spout 531 for pouring large volumes or the pretreatment spout 532 for the controlled pouring of small volumes. A measuring cup 504 is threadedly attached to the slanted transition collar 514.

### Adjustable Lever Spout

In a suitable embodiment in FIG. 8, the bottle 600 has a pouring spout 640 with a lever 641 that can be controlled between a large orifice adjustment side 642 for pouring and a small orifice adjustment side 643 for pretreatment. An oblique measuring cup 604 is frictionally attached to the slanted transition collar 614.

### Adjustable Twist Spout

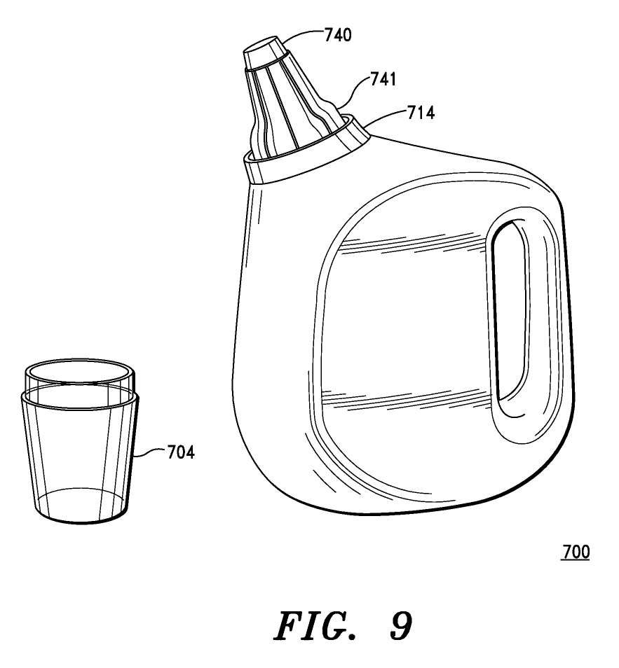

In a suitable embodiment in FIG. 9, the bottle 700 has a pouring spout 740 that twists to adjust the rate of liquid released from the spout 740. The spout 740 has external fins 741 to aid in twisting control. A measuring cup 704 is frictionally attached to the slanted transition collar 714. Examples of a variable controlled spout are disclosed in U.S. Pat. No. 5,000,360 to Lown et al., which is incorporated by reference in their entirety herein.

### Pretreater Button Spout

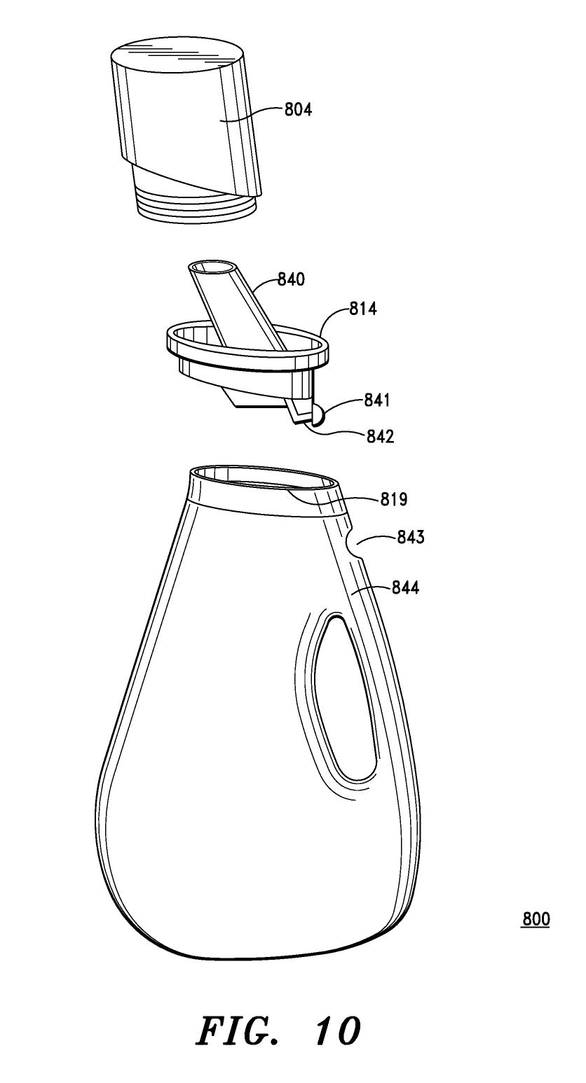

In a suitable embodiment in FIG. 10, the bottle 800 has a transition collar 814 with a pretreatment activation button 841 that moves a flow valve 842 that partially closes the pouring spout 840 so that a reduced flow rate for pretreatment is achieved. When the transition collar 814 is fixedly attached to the bottle finish 819 the activation button 841 extends through an access opening 843 in the bottle sidewall 844. Release of the pretreatment activation button 841 allows a greater pouring flow rate for filling the measuring cup 804. Examples of a button controlled spout are disclosed in U.S. Pat. No. 4,570,826 to Fattori and U.S. Pat. No. 6,201,924 to Suck et al., which are incorporated by reference in their entirety herein.

### Variable Pitcher

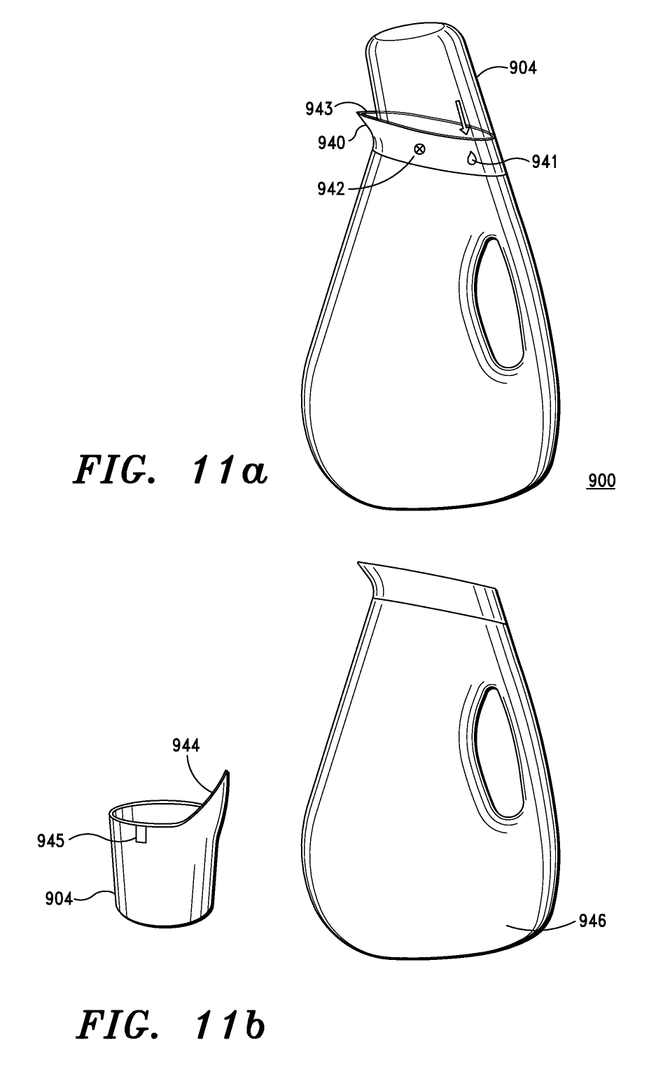

In a suitable embodiment in FIG. 11a and 11b, the bottle 900 has a pouring spout 940 with a partially open position 941 for pretreatment and a closed position 942 than seals off the pouring spout opening 943. Rotation of a flexible measuring cup 904 having a spout blocking dam 944 changes the pouring spout 940 between the partially open position 941 and the closed position 942. The measuring cup 904 has a stop 945 that limits rotation of the measuring cup 904 past the partially open position 941. Inward pressure on the measuring cup 904 adjacent to the stop 945 allows the measuring cup to be rotated further and completely removed from the container 946. When the measuring cup 904 is removed, the pouring spout 940 is fully open for filling the measuring cup 940 or pouring directly for use. Examples of a rotating measuring cup are disclosed in U.S. Pat. App. 20030209572 to Myers, which is incorporated by reference in their entirety herein.

### Pretreater Pump

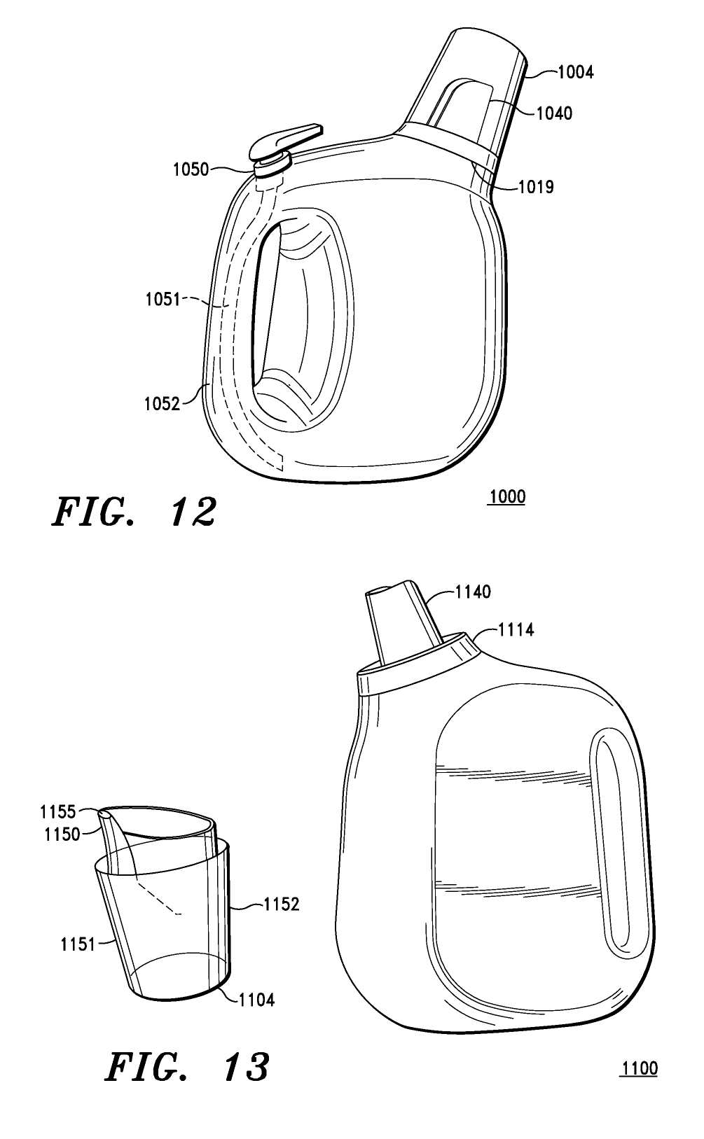

As shown in a suitable embodiment in FIG. 12, the bottle 1000 has a pretreater pump 1050 on the handle side of the bottle 1000 with a flexible dip tube 1051 extending in the handle channel 1052 and a pouring spout 1040 on the top side of the bottle 900 away from the handle channel 1052. The pouring spout 1040 is covered by a measuring cup 1004 which attaches to the slanted bottle finish 1019.

Pretreater Cup with Spout

As shown in a suitable embodiment in FIG. 13, the bottle 1100 has a measuring cup 1104 with an integrated cup pouring spout 1150 having an orifice 1155 on one side 1151 of the measuring cup 1104 for pretreatment. The other side of the measuring cup 1152 can be used for greater pouring rates from the measuring cup 1104. The measuring cup 1104 attaches to the transition collar 1114 over the bottle pouring spout 1140. Examples of a modified spout are disclosed in U.S. Pat. No. 6,427,879 to Caldwell, which is incorporated by reference in their entirety herein.

This invention has been described herein in detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A plastic container which comprises:
a plastic container body for housing a liquid having an upwardly extending finish provided with a dispensing opening;
a transition collar mounted on the finish, the collar having an forwardly projecting pouring spout and a circumscribing wall spaced from the pouring spout, the circumscribing wall including a fastening means on the internal surface;
a measuring cup adapted to serve as a closure for the container, the measuring cup having an open mouth, a top surface, a depending skirt-like sidewall and fastening means on the external surface of the sidewall adapted to cooperate with the transition collar fastening means;
the measuring cup having a pretreatment closure that allows application of the liquid when the measuring cup is attached to the container.

2. The plastic container of claim 1, wherein the pretreatment closure is a tilt-top closure.

3. The plastic container of claim 1, wherein the pretreatment closure is a turret cap.

4. The plastic container of claim 1, wherein the measuring cup has a slanted attachment base.

5. The plastic container of claim 1, wherein the dispensing opening is slanted in a forward direction.

6. The plastic container of claim 1, wherein the top surface is slanted in a forward direction.

7. A plastic container which comprises:
a plastic container body for housing a liquid having an upwardly extending finish provided with a dispensing opening;
a transition collar mounted on the finish, the collar having a pouring spout and a circumscribing wall spaced from the pouring spout, the circumscribing wall including a fastening means on the internal surface;
a measuring cup adapted to serve as a closure for the container, the measuring cup having an open mouth, a top surface, a depending skirt-like sidewall and fastening means on the external surface of the sidewall adapted to cooperate with the transition collar fastening means;
wherein a portion of the sidewall is at an angle of greater than 90 degrees to the top surface.

8. The plastic container of claim 7, wherein the measuring cup has a pretreatment closure.

9. The plastic container of claim 8, wherein the pretreatment closure is a tilt-top closure.

10. The plastic container of claim 8, wherein the pretreatment closure is a turret cap.

11. The plastic container of claim 7, wherein the measuring cup has a top compartment accessed by a flip cap and containing a functional scrubber.

12. The plastic container of claim 7, wherein the measuring cup has an integrated cup pouring spout.

13. A plastic container which comprises:
a plastic container body for housing a liquid having an upwardly extending finish provided with a dispensing opening;
a transition collar mounted on the finish, the collar having a pouring spout and a circumscribing wall spaced from the pouring spout, the circumscribing wall including a fastening means on the internal surface;
a measuring cup adapted to serve as a closure for the container, the measuring cup having an open mouth, a top surface, a depending skirt-like sidewall and fastening means on the external surface of the sidewall adapted to cooperate with the transition collar fastening means;
wherein the pouring spout has an adjustment mechanism to control the flow rate of liquid from the pouring spout.

14. The plastic container of claim 13, wherein the adjustment mechanism is a rotating dual spout.

15. The plastic container of claim 13, wherein the adjustment mechanism is an adjustable lever spout.

16. The plastic container of claim 13, wherein the adjustment mechanism is an adjustable twist spout.

17. The plastic container of claim 13, wherein the adjustment mechanism is a pretreater button spout.

18. The plastic container of claim 13, wherein the adjustment mechanism is a rotating measuring cup that rotates to open the spout for pretreatment and removes to open the spout for pouring.
